(19) United States
(12) Patent Application Publication
(10) Pub. No.: US 2026/0277081 A1
(43) Pub. Date: Sep. 17, 2026

(54) FIXING STRUCTURE AND CAMERA DEVICE

(71) Applicants: Lei PAN, Shenzhen (CN); Global Media Industry Group Co., Ltd., Shenzhen (CN)

(72) Inventor: Lei PAN, Shenzhen (CN)

(73) Assignees: Lei PAN, Shenzhen (CN); Global Media Industry Group Co., Ltd., Shenzhen (CN)

(21) Appl. No.: 19/106,236

(22) PCT Filed: Dec. 18, 2023
(86) PCT No.: PCT/CN2023/139505

§ 371 Date: Feb. 25, 2025

(30) Foreign Application Priority Data
Dec. 7, 2023 (CN) 202311679787.4

(51) Int. Cl. G03B 17/56; B60R 1/20; G03B 30/00

(52) U.S. Cl. CPC G03B 17/561; B60R 1/20; G03B 30/00

(57) ABSTRACT

A fixing structure and a camera device are provided. The fixing structure is configured to fix a camera. The camera includes a first portion and a second portion. The first portion and the second portion are located on different sides of the camera. The fixing structure includes an outer housing, a bracket and an inner housing. The outer housing includes a first snap-fit hole, and the first portion is snap-fitted in the first snap-fit hole. The bracket is rotatably connected to the outer housing. The second portion is rotatably connected to the bracket, and the second portion is connected to the outer housing. The inner housing includes a second snap-fit hole. The first portion is snap-fitted in the second snap-fit hole. The inner housing is connected to the outer housing. The present application solves the problem in existing camera fixing devices where cameras tend to sag because of rotation.

### CROSS-REFERENCE TO RELATED APPLICATION

The present application claims the benefit of priority to Chinese Patent Application No. 202311679787.4, entitled “FIXING STRUCTURE AND CAMERA DEVICE”, filed with CNIPA on Dec. 7, 2023, the disclosure of which is incorporated herein by reference in its entirety for all purposes.

### FIELD OF THE INVENTION

The present application relates to technical field of on-board electronics, in particular to a fixing structure and a camera device.

### BACKGROUND OF THE INVENTION

When using a streaming rear-view mirror, a camera needs to be adhered to a windshield in order to provide real-time images for the streaming rear-view mirror. A tilt angle of a rear windshield varies greatly from vehicle to vehicle. For example, a rear windshield of a pickup truck has a tilt angle of about 90 degrees, while rear windshields of some sports cars have tilt angles of about 20 degrees. This causes a lot of trouble for manufacturers when supplying streaming rear-view mirrors, as the manufacturers do not know whether an end customer's vehicle is a sports car or a pickup truck at the time of shipment. A common practice is to equip each streaming rear-view mirror with several types of cameras to adapt to different vehicle models, but this increases the manufacturers' costs.

In order to adapt to two vehicle models with different windshield tilt angles, a housing and a camera bracket may be provided. One end of the camera is fixed to the housing, and the camera bracket is rotatable relative to the housing. When the camera needs to be adapted to a windshield with a 20-degree tilt angle, the camera bracket is rotated to an angle suitable for the windshield with a 20-degree tilt angle. When the camera needs to be adapted to a windshield with a 90-degree tilt angle, the camera bracket is rotated to an angle suitable for the windshield with a 90-degree tilt angle. However, the existing camera is fixed to the housing at only one end, which leads to the problem of sagging because of rotating around the fixed end and even a risk of detachment from the housing with vehicle vibrations during driving. Therefore, existing camera fixation devices suffer from the problem of the camera tending to sag because of rotation.

### SUMMARY OF THE INVENTION

A fixing structure that prevents a camera from easily sagging because of rotation is provided. The fixing structure is configured to fix a camera and includes a first portion and a second portion. The first portion and the second portion are located on different sides of the camera. The fixing structure includes an outer housing, a bracket, and an inner housing. The outer housing includes a first snap-fit hole, and the first portion is snap-fitted in the first snap-fit hole. The bracket is rotatably connected to the outer housing. The second portion is rotatably connected to the bracket, and the second portion is connected to the outer housing. The inner housing includes a second snap-fit hole, and the first portion is snap-fitted in the second snap-fit hole. The inner housing is connected to the outer housing.

Optionally, an inner side of the outer housing includes first a snap-fit teeth portion, and an outer side of the bracket includes a second snap-fit teeth portion. The second snap-fit teeth portion and the first snap-fit teeth portion are coaxially disposed and engage with each other.

Optionally, the first snap-fit teeth portion includes a plurality of first snap-fit teeth, and the second snap-fit teeth portion includes a plurality of second snap-fit teeth. The number of the first snap-fit teeth is less than the number of the second snap-fit teeth.

Optionally, the outer housing includes an avoidance slot, and the bracket includes a support arm. The second snap-fit teeth portion is provided on the support arm, and the avoidance slot is used to avoid the support arm.

Optionally, the inner housing includes a first limiting portion, which is spaced apart from the second snap-fit hole, and the camera is snap-fitted between an edge of the second snap-fit hole and the first limiting portion.

Optionally, the inner housing includes a second limiting portion, which is spaced apart from the first limiting portion, and the second portion abuts against the second limiting portion.

Optionally, the inner housing includes a notch. The second limiting portion is located at an edge of the notch, and the second portion is exposed at the notch.

Optionally, the number of the second limiting portion is two, and a distance between the two second limiting portions is approximately the same as a width of a camera body.

Optionally, the fixing structure further includes a fastener, the second portion includes a screw hole, the outer housing includes a first through hole, and the bracket includes a second through hole. A first end of the fastener is passed through the first through hole and second through hole and screwed into the screw hole, and a second end of the fastener abuts against an edge of the first through hole.

The present application also provides a camera device. The camera device includes a camera and the fixing structure, and the camera is fixed to the fixing structure.

The present application has the following beneficial effects: an outer housing, a bracket and an inner housing are provided. A camera includes a first portion and a second portion. The first portion and the second portion are located on different sides of the camera. The outer housing includes a first snap-fit hole, and the first portion is snap-fitted in the first snap-fit hole. The bracket is rotatably connected to the outer housing. The second portion is rotatably connected to the bracket, and the second portion is connected to the outer housing. The inner housing includes a second snap-fit hole, and the first portion is snap-fitted in the second snap-fit hole. The inner housing is connected to the outer housing,

Since the camera includes the first portion and the second portion on different sides, the first portion is snap-fitted in the first snap-hole of the outer housing and the second snap-hole of the inner housing, and the second portion is connected to the outer housing, the camera will not rotate around the first portion and sag, and thus will not be dislodged from the outer housing.

Described above is only a summary of the technical solutions of the present application. To understand the technical means of the present application more clearly and carry them out according to the contents of the specification, the present application is described in detail below with preferred embodiments of the present application and in conjunction with the accompanying drawing.

### BRIEF DESCRIPTION OF DRAWINGS

FIG. 1 is an exploded view of a camera device according to one embodiment of the present application;

FIG. 2 is a cross-sectional view of a camera device in a plane parallel to YOZ plane according to one embodiment of the present application;

FIG. 3 is a cross-sectional view of a camera device in a plane parallel to XOZ plane according to one embodiment of the present application;

FIG. 4 is a cross-sectional view of a camera device in a plane parallel to XOY plane according to one embodiment of the present application (a bracket is omitted);

FIG. 5A is a perspective view of an outer housing according to one embodiment of the present application;

FIG. 5B is an enlarged view of part A in FIG. 5A;

FIG. 6A is a perspective view of a bracket according to one embodiment of the present application;

FIG. 6B is an enlarged view of part B in FIG. 6A;

FIG. 7 is a perspective view of an inner housing according to one embodiment of the present application;

FIG. 8 is a schematic installation diagram of a fixing structure according to one embodiment of the present application (a bracket is at an angle of installation to a windshield with a 90-degree tilt angle, and the windshield is shown only partially);

FIG. 9 is a schematic installation diagram of a fixing structure according to another embodiment of the present application (a bracket is at an angle of installation to a windshield with a 20-degree tilt angle, and the windshield is shown only partially);

FIG. 10 is a perspective view of a camera device according to one embodiment of the present application; and

FIG. 11 is a perspective view of a camera device according to another embodiment of the present application.

Reference numerals

| | |
|---|---|
| 1 | fixing structure |
| 10 | outer housing |
| 100 | first snap-fit hole |
| 101 | first snap-fit teeth portion |
| 1010 | first snap-fit tooth |
| 102 | first front wall |
| 1020 | avoidance slot |
| 103 | first through hole |
| 104 | screw post |
| 11 | bracket |
| 110 | support arm |
| 1100 | second snap-fit teeth portion |
| 11000 | second snap-fit tooth |
| 1101 | second through hole |
| 111 | fitting portion |
| 12 | inner housing |
| 120 | second snap-fit hole |
| 121 | first limiting portion |
| 122 | second front wall |
| 123 | second limiting portion |
| 1230 | transition segment |
| 124 | notch |
| 13 | fastener |
| 2 | camera |
| 20 | first portion |
| 21 | second portion |
| 210 | screw hole |
| 22 | lens |
| 23 | camera body |
| 3 | windshield |

### DETAILED DESCRIPTION

The specific embodiments are described below to illustrate the implementation of the present application, and those skilled in the art can easily understand other advantages and effects of the present application from the content disclosed in this specification.

It should be noted that the embodiments and features of the embodiments in the present application can be combined with each other as long as there is no conflict. The present application will be described in detail below with reference to the accompanying drawings in conjunction with embodiments. To enable those skilled in the art to better understand the solutions of the present application, the technical solutions in the embodiments of the present application will be described below clearly and completely in conjunction with the accompanying drawings in the embodiments of the present application. Obviously, the described embodiments are only a part of the embodiments of the present application, and not all the embodiments. All other embodiments obtained by those of ordinary skill in the art without creative work, based on the embodiments in the present application, shall fall into the protection scope of the present application.

It is to be noted that the terms “first” and “second” and the like in the description and claims of the present application and the above-mentioned drawings are used for distinguishing similar objects, and do not need to be used for describing a specific order or sequence. In addition, the terms “include” and “have”, as well as any variations thereof are intended to cover non-exclusive inclusion, e.g., a process, method, system, product or device that includes a series of steps or units does not need to be limited to steps or units that are clearly listed, but may include other steps or units that are not clearly listed or are inherent to the process, method, product or device.

In the present application, unless otherwise specified and limited, terms such as “installation”, “connection”, “linkage”, “fixation”, “retention” and the like should be broadly understood, for example, it can be a fixed connection, a detachable connection, or an integral connection; it can be a mechanical connection, or an electrical connection; it can be a direct connection, or an indirect connection through an intermediate medium, and it also can be communication inside two components. For those skilled in art, the specific meanings of the above terms in the context can be understood according to the specific situation.

To facilitate description, a rectangular coordinate system O-XYZ is established in each figure. An X-axis aligns with a width direction of an inner housing 12, a Y-axis aligns with a length direction of the inner housing 12, and a Z-axis aligns with a height direction of the inner housing 12. The X-axis may be set coaxially with a screw hole 210 of a camera 2. Positive directions of the X-, Y- and Z-axes are consistent in all figures with coordinate systems.

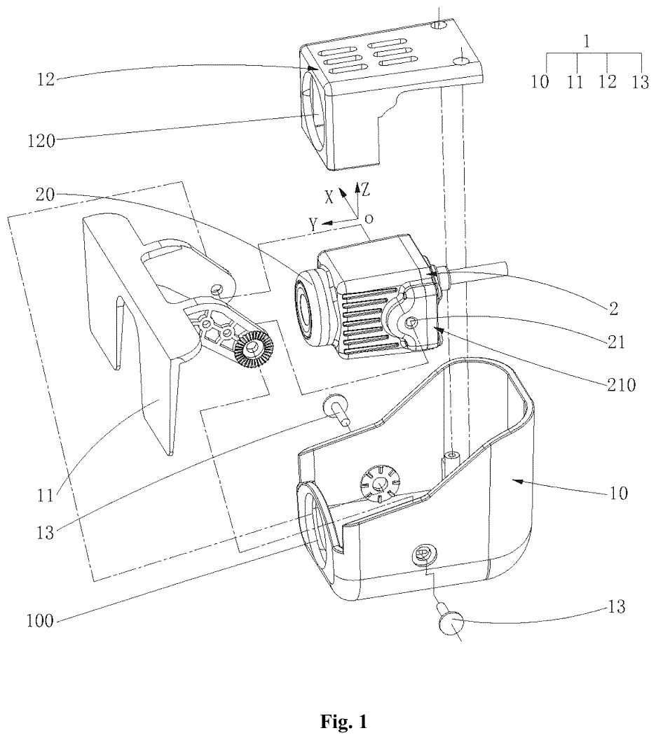

As shown in FIG. 1, in this embodiment, a fixing structure 1 is provided to fix a camera 2. The camera 2 includes a first portion 20 and a second portion 21. The first portion 20 and the second portion 21 are located on different sides of the camera 2. The fixing structure 1 includes an outer housing 10, a bracket 11, and an inner housing 12. The outer housing 10 includes a first snap-fit hole 100. The first portion 20 is snap-fitted in the first snap-fit hole 100. The bracket 11 is rotatably connected to the outer housing 10. The second portion 21 is rotatably connected to the bracket 11, and the second portion 21 is connected to the outer housing 10. The inner housing 12 includes a second snap-fit hole 120. The first portion 20 is snap-fitted in the second snap-fit hole 120. The inner housing 12 is connected to the outer housing 10.

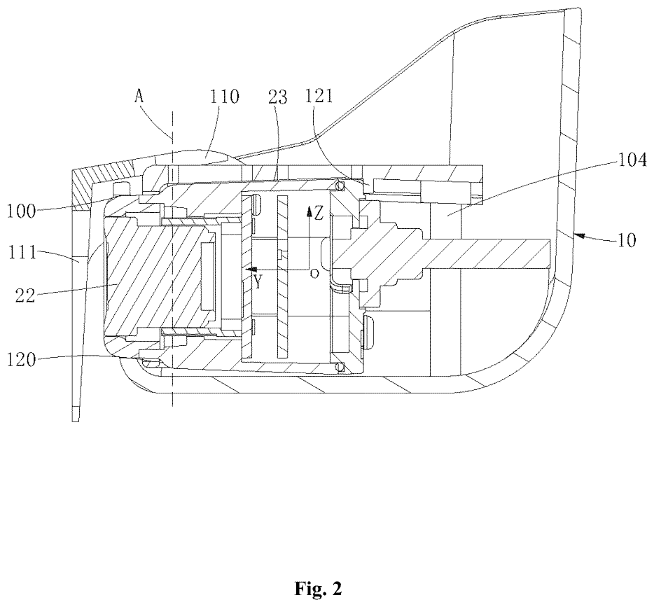

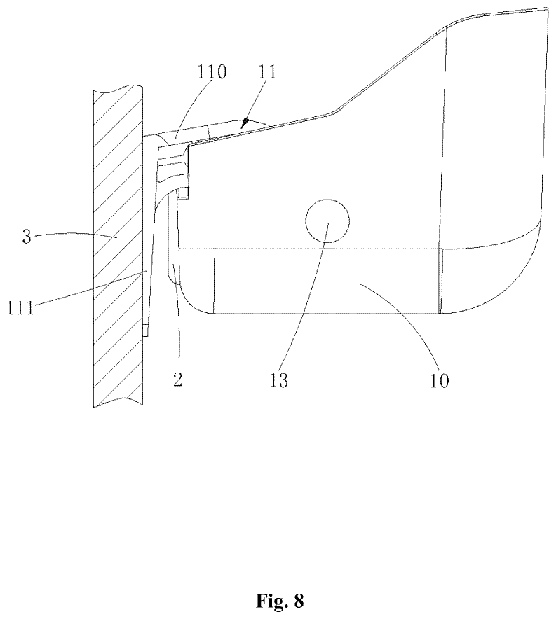

Referring to FIGS. 1 and 2 simultaneously, the bracket 11 includes a fitting portion 111 to fit against a windshield 3 of a vehicle (please refer to FIG. 8 for the windshield). A right bottom end of the bracket 11 may be rotatably connected to the outer housing 10 and the second portion 21. The camera 2 may be substantially cube-shaped. The camera 2 may capture images in a direction parallel to the Y-axis. The second portion 21 may be a middle-rear portion of the camera 2. The second portion 21 is rotatably connected to the bracket 11 means that the bracket 11 may rotate relative to the second portion 21. The camera 2 is stationary relative to the outer housing 10. The second portion 21 may be screwed to the outer housing 10 by fasteners 13. The camera 2 may include a lens 22 and a camera body 23. The lens 22 is configured to capture images. The camera body 23 is configured to fix the lens 22 and the second portion 21. The cross-section of the lens 22 may be circular. The cross-sectional shape of the camera body 23 may be rectangular. A front portion of the lens 22 may be exposed at a front side of the camera body 23.

Referring to FIGS. 1 and 2 simultaneously, optionally, the front portion of the lens 22 may protrude in a direction toward a front side face of the camera body 23, i.e., the front portion of the lens 22 may protrude from the front side face of the camera body 23 in the direction parallel to the Y-axis. The first portion 20 may be a head of the camera 2. The first portion 20 may be located on a front side of the camera 2. The first portion 20 includes the front portion of the lens 22 and a front portion of the camera body 23. As shown in FIG. 2, a plane A passing through a bottom surface of the first portion 20 and parallel to an XOZ plane is provided. A portion of the camera 2 located to the left of plane A is the first portion 20. The first portion 20 snap-fitted in the second snap-fit hole 120 can mean that a front portion of the camera 2 is exposed through the second snap-fit hole 120 and the front portion of the camera body 23 abuts against an inner edge of the second snap-fit hole 120. The second snap-fit hole 120 can prevent the camera 2 from moving in a positive direction parallel to the Y-axis.

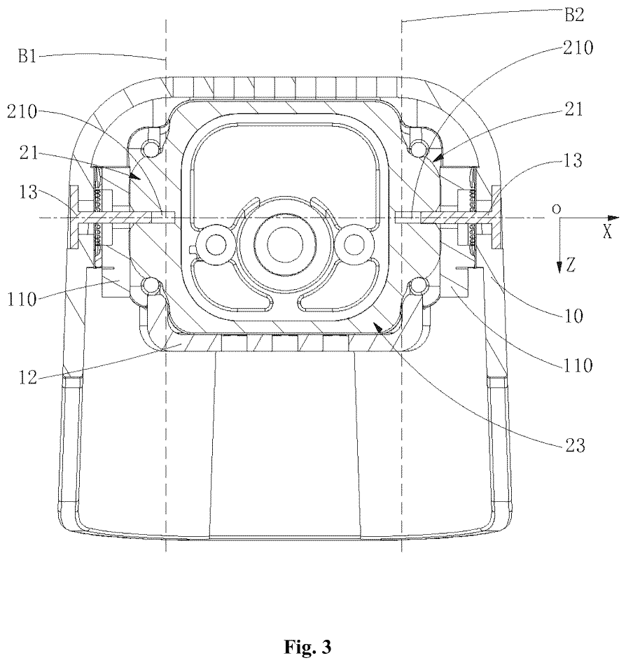

Referring to FIGS. 2 and 3 simultaneously, an area of the front side face of the camera body 23 is larger than a cross-sectional area of the second snap-fit hole 120, and a diameter of a cross-section of the front portion of the lens 22 is approximately the same as diameters of the first snap-fit hole 100 and the second snap-fit hole 120, so that the front portion of the lens 22 can protrude through the first snap-fit hole 100 and the second snap-fit hole 120, while the camera body 23 is blocked by the inner edge of the second snap-fit hole 120. The second portion 21 may protrude in a direction perpendicular to a left side face or a right side face of the camera body 23, i.e., the second portion 21 may protrude from the left side face and the right side face of the camera body 23 in a direction parallel to the X-axis. The number of second portion 21 may be two, and the two second portions 21 are disposed on the left side face and the right side face of the camera 2, respectively.

As shown in FIG. 3, a plane B1 and a plane B2 respectively passing through each bottom surface of a left-side second portion 21 and a right-side second portion 21 and parallel to a YOZ plane are provided. A portion of the camera 2 that protrudes beyond the camera body 23 from the plane B1 is the left-side second portion 21, and a portion of the camera 2 that protrudes beyond the camera body 23 from the plane B2 is the right-side second portion 21.

Referring to FIGS. 1 and 2 simultaneously, the outer housing 10 may be a housing with an opening at the top, and the inner housing 12 and the camera 2 may be placed into the outer housing 10 through the opening at the top of the outer housing 10. The bracket 11 may be pivotally connected to the outer housing 10. The bracket 11 may be pivotally connected to the second portion 21. The bracket 11 may be partially clamped between the second portion 21 and the outer housing 10. The bracket 11 may rotate about the X-axis. The second snap-fit hole 120 may be located on an inner side of the first snap-fit hole 100.

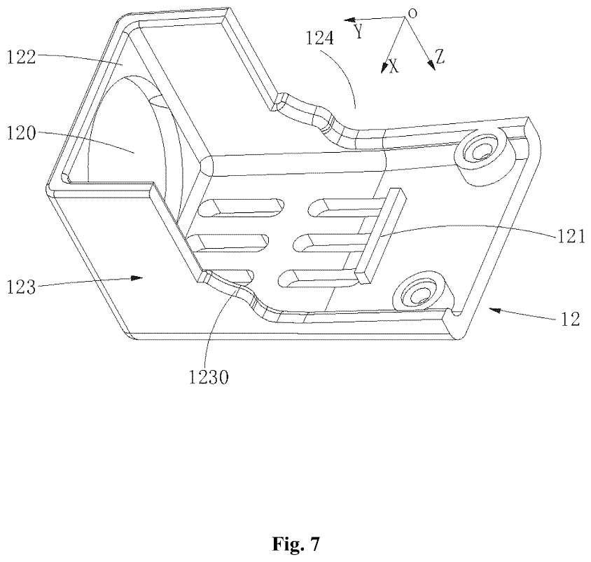

Referring to FIGS. 1 and 2 simultaneously, the inner housing 12 as a whole may be three-dimensionally L-shaped. The second snap-fit hole 120 may be a circular hole, and the second snap-fit hole 120 may be disposed at a front portion of the inner housing 12. The second snap-fit hole 120 may be disposed in a second front wall 122 of the inner housing 12 (please refer to FIG. 7 for the second front wall 122). A central axis of the second snap-fit hole 120 may be parallel to the Y-axis. A rear portion of the inner housing 12 may be fixed to the outer housing 10 by screws. The inner housing 12 may be disposed inside the outer housing 10. The bracket 11, the inner housing 12, and the outer housing 10 may be made of plastic (for example, the bracket 11, the inner housing 12, and the outer housing 10 may be made of PC+ABS or PC).

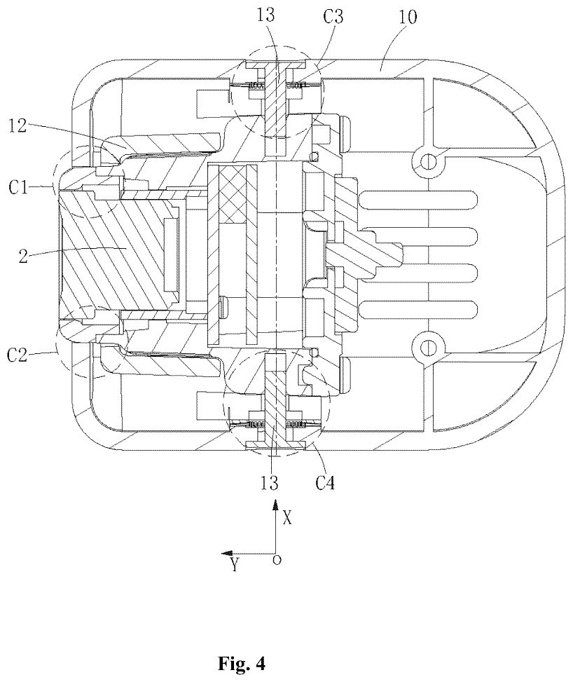

Referring to FIGS. 1 and 4 simultaneously, since the camera 2 includes the first portion 20 and the second portion 21 on different sides, the first portion 20 is snap-fitted in the first snap-hole 100 of the outer housing 10 and the second snap-hole 120 of the inner housing 12, and the second portion 21 is connected to the outer housing 10, the camera 2 will not rotate around the first portion 20 and sag, and thus will not be dislodged from the outer housing 10. Specifically, as shown in FIG. 4, since at least four fixing regions C1 to C4 are provided between the camera 2, and the outer housing 10, and the inner housing 12, i.e., in the area C1 and the area C2, the camera 2 is fixed by using the first snap-fit hole 100 and the second snap-fit hole 120, and in the area C3 and the area C4, the camera 2 is fixed by using the fasteners 13, the camera 2 will not rotate relative to the area C1 and the area C2.

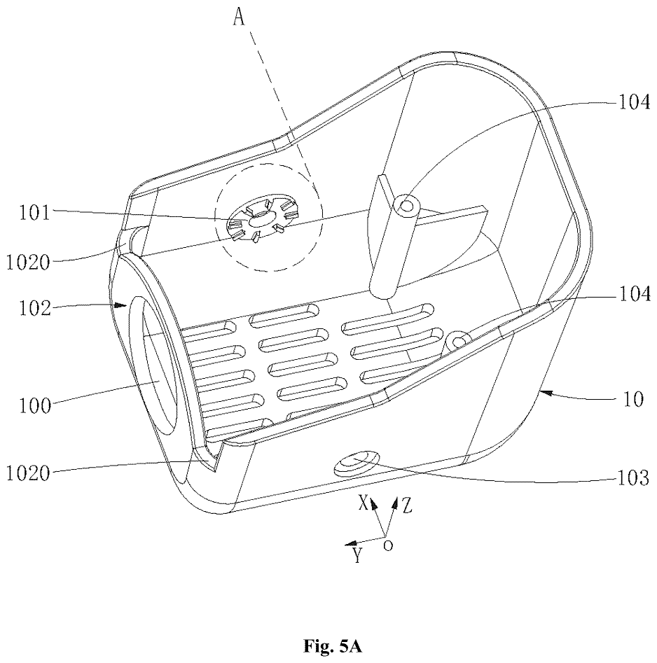

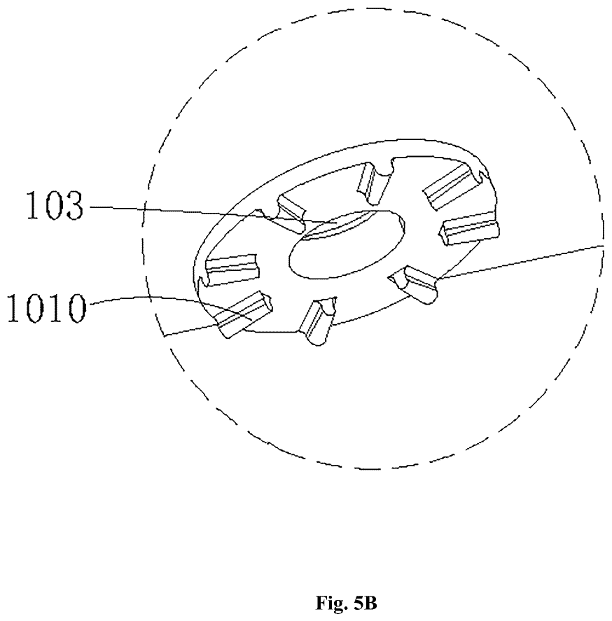

Referring to FIGS. 1 and 5A simultaneously, optionally, the outer housing 10 includes a first snap-fit hole 100 to allow the camera 2 to be exposed, i.e., the outer housing 10 allows the front portion of the lens 22 (please refer to FIG. 2 for the lens 22) to be exposed. The first snap-fit hole 100 may be a circular hole, and the first snap-fit hole 100 may be disposed on a front side of the outer housing 10. The first snap-fit hole 100 may be disposed in a first front wall 102 of the outer housing 10. The first snap-fit hole 100 and the second snap-fit hole 120 may be provided coaxially. The first portion 20 is snap-fitted in the first snap-fit hole 100, which mean an interference fit between a circumferential surface of the front portion of the camera 2 and the first snap-fit hole 100. The outer housing 10 may include screw posts 104, and the inner housing 12 may be fixed to the screw posts 104 of the outer housing 10 by screws. For example, the rear portion of the inner housing 12 may be fixed to the screw posts 104 by screws. By snap-fitting the first portion 20 in the first snap-fit hole 100, the front portion of the camera 2 may be further fixed, and the inner housing 12 may be fixed by the camera 2, thereby preventing the inner housing 12 from moving in the direction parallel to the X-axis.

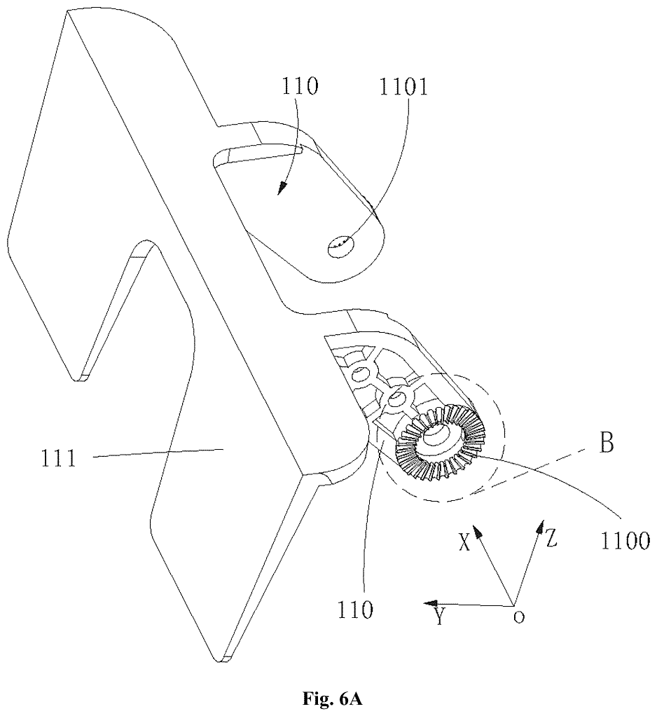

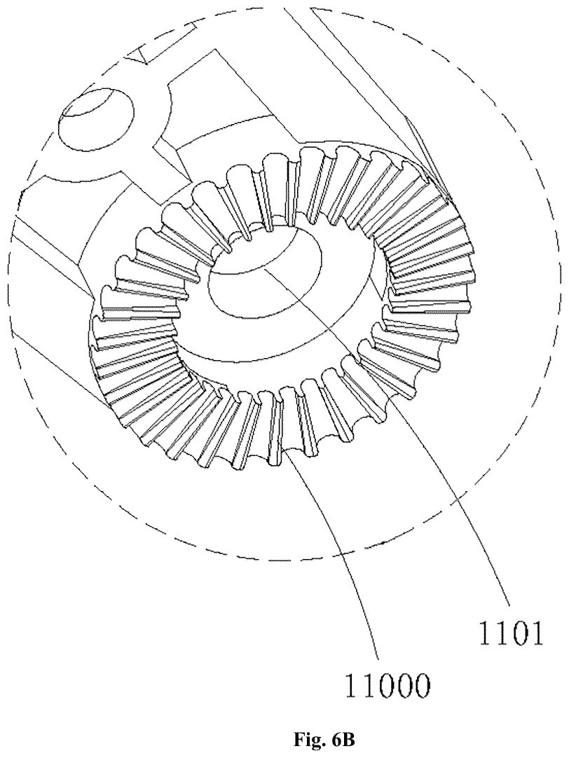

Referring to FIGS. 1, 2, and 5A simultaneously, to install the camera 2, the camera 2 may be first snap-fitted between the second snap-fit hole 120 and a first limiting portion 121 of the inner housing 12. Then, as a whole, the camera 2 and the inner housing 12 are placed into the outer housing 10 through the opening at the top of the outer housing 10, and the inner housing 12 is fixed to the screw posts 104 of the outer housing 10. Subsequently, tail ends of two support arms 110 (please refer to FIG. 6A for the support arm 110) of the bracket 11 are respectively snap-fitted to a left inner wall and a right inner wall of the outer housing 10. Finally, a first snap-fit teeth portion 101 (please refer to FIG. 5A for the first snap-fit teeth portion 101), a second snap-fit teeth portion 1100 (please refer to FIG. 6A for the second snap-fit teeth portion 1100) and the screw hole 210 are aligned, and then tail end of the fastener 13 is passed through first through hole 103 and second through hole 1101 and screwed into the screw hole 210, thus completing fixation of the camera 2.

Referring to FIGS. 1, 5A, and 6A simultaneously, optionally, each inner side of the outer housing 10 includes a first snap-fit teeth portion 101, and each outer side of the bracket 11 includes a second snap-fit teeth portion 1100. The second snap-fit teeth portion 1100 and the first snap-fit teeth portion 101 are disposed coaxially and engaged with each other respectively. The number of the first snap-fit teeth portions 101 may be two, and the two first snap-fit teeth portions 101 are disposed in the middle of the left inner wall of the outer housing 10 and in the middle of the right inner wall of the outer housing 10 respectively. The second snap-fit teeth portion 1100 may be pivotally connected to the first snap-fit teeth portion 101. For example, a fastener 13 may be used to pivotally connect the first snap-fit teeth portion 101 and the second snap-fit teeth portion 1100. In the case where the fastener 13 is used as a pivot for the first snap-fit teeth portion 101 and the second snap-fit teeth portion 1100, threads may be provided only at the tail end of the fastener 13, while a segment of the fastener 13 used as the pivot is smooth. As the pivot for the first snap-fit teeth portion 101 and the second snap-fit teeth portion 1100, the fastener 13 simultaneously serves to connect the camera 2, the bracket 11, and the outer housing 10, and to provide a pivot for the bracket 11.

Referring to FIGS. 1, 5A, 5B, 6A and 6B simultaneously, optionally, the first snap-fit teeth portion 101 includes a plurality of first snap-fit teeth 1010, and the plurality of first snap-fit teeth 1010 may be uniformly distributed with reference to the X-axis. The first snap-fit teeth portion 101 is disposed on the inner side of the outer housing 10, and the second snap-fit teeth portion 1100 is disposed on the outer side of the bracket 11. A left inner side and a right inner side of the bracket 11 may abut against the left-side second portion 21 and the right-side second portion 21, respectively. Since the second portion 21 is usually made of a metal material (e.g., the second portion 21 may be made of an aluminum alloy or a zinc alloy) and the bracket 11 is usually plastic, a friction coefficient between the bracket 11 and the second portion 21 is greater than a friction coefficient between a plastic bracket and a plastic housing in existing rotatable connections, thus allowing for a greater friction force between the bracket 11 and the second portion 21.

Referring to FIGS. 5B and 6B simultaneously, optionally, the first snap-fit teeth portion 101 includes a plurality of first snap-fit teeth 1010, and the second snap-fit teeth portion 1100 includes a plurality of second snap-fit teeth 11000. The number of the first snap-fit teeth 1010 is less than the number of the second snap-fit teeth 11000. The plurality of second snap-fit teeth 11000 may be uniformly distributed with reference to the X-axis. The number of the first snap-fit teeth 1010 is less than the number of the second snap-fit teeth 11000 to ensure that the bracket 11 (please refer to FIG. 1 for the bracket 11) has a plurality of adjustable angles, while simultaneously reducing the likelihood of jamming between the first snap-fit teeth 1010 and the second snap-fit teeth 11000 (the second snap-fit teeth 11000 can rotate between two first snap-fit teeth 1010 without being blocked, thus preventing jamming).

Referring to FIGS. 1, 5A, and 6A simultaneously, the adjustable angles of the bracket 11 may be determined by an included angle between the adjacent second snap-fit teeth 11000 and the number of second snap-fit teeth 11000 that have been rotated. The number of the second snap-fit teeth portions 1100 may be two, and the two second snap-fit teeth portions 1100 are disposed on a left outer wall and a right outer wall of the bracket 11, respectively. For example, the two second snap-fit teeth portions 1100 may be disposed on an outer side face of a left support arm 110 and an outer side face of a right support arm 110, respectively. A thickness of the second snap-fit teeth portion 1100 is approximately the same as a distance between the second portion 21 and an end face of the first snap-fit teeth portion 101 to prevent the camera 2 from wobbling. A thickness direction of the second snap-fit teeth portion 1100 is parallel to the X-axis.

Referring to FIGS. 1, 5A, and 6A simultaneously, optionally, the outer housing 10 includes an avoidance slot 1020, and the bracket 11 includes the support arm 110. The second snap-fit teeth portion 1100 is provided on the support arm 110, and the avoidance slot 1020 is used to avoid the support arm 110. The avoidance slot 1020 may be provided on an upper end of the first front wall 102. The number of the avoidance slots 1020 and the support arms 110 may each be two, and they are disposed to correspond to each other one by one. A cross-section of the avoidance slot 1020 may be rectangular. The two avoidance slots 1020 may be disposed on left and right sides of the first snap-fit hole 100, respectively.

Referring to FIGS. 1, 5A, and 6A simultaneously, optionally, the bracket 11 may include two support arms 110. The second snap-fit teeth portion 1100 is disposed on an outer side face of a tail end of each support arm 110. The tail end of the support arms 110 may be located inside the outer housing 10. Inner side faces of the tail ends of the support arms 110 may abut against the second portion 21. The avoidance slot 1020 can provide an avoidance space for the support arms 110 to continue rotating when the bracket 11 needs to be rotated for installation to a 90-degree windshield 3 of a vehicle, and the bottom of the avoidance slot 1020 can act as a stop for the support arm 110 to prevent the bracket 11 from being excessively turned. The two support arms 110 may rotate about the X-axis. A thickness of the support arms 110 may be approximately equal to a width of the avoidance slot 1020. Thickness directions of the support arms 110 are parallel to the X-axis.

Referring to FIGS. 1, 5A, and 6A simultaneously, optionally, the fixing structure 1 further includes a fastener 13, the second portion 21 includes a screw hole 210, the outer housing 10 includes a first through hole 103, and the bracket 11 includes a second through hole 1101. A first end of the fastener 13 is passed through the first through hole 103 and the second through hole 1101 and screwed into the screw hole 210, while a second end of the fastener 13 abuts against an edge of the first through hole 103. The fastener 13 may be a screw. The numbers of the fasteners 13, the screw holes 210, the first through holes 103, and the second through holes 1101 may each be two, and they are disposed in a one-to-one correspondence manner.

The two screw holes 210 may be disposed on left and right sides of the camera 2, respectively. The two first through holes 103 may be disposed on two sides of the outer housing 10, respectively. Tail ends of the fasteners 13 may be screwed into the screw holes 210, and heads of the fasteners 13 may abut against edges of outer ends of the first through holes 103. The edges of the first through holes 103 may be portions of the outer housing 10 that surround the outer ends of the first through holes 103, and diameters of the edges of the first through holes 103 may be substantially the same as diameters of the heads of the fasteners 13.

Referring to FIGS. 1, 5A, and 6A simultaneously, each first through hole 103 may be disposed coaxially in one-to-one correspondence with the corresponding first snap-fit teeth portion 101. The two second through holes 1101 may be disposed at the tail ends of the two support arms 110, respectively. Each second through hole 1101 may be disposed coaxially in one-to-one correspondence with the corresponding second snap-fit teeth portion 1100. The first end of each of the fasteners 13 is passed through each of the first through holes 103 and second through holes 1101 and then screwed into each of the screw holes 210, i.e., each corresponding screw hole 210, first through hole 103, and second through hole 1101 may be disposed coaxially, which means that only one fastener 13 needs to be used on each of left and right sides of the outer housing 10 respectively to simultaneously fix both the bracket 11 and the camera 2. This eliminates the need for separate screws to fix the bracket 11 to the outer housing 10 and to fix the outer housing 10 to the camera 2, thereby reducing the number of fasteners 13 required.

Referring to FIGS. 1, 5A, and 6A simultaneously, the reduced number of fasteners 13 may also reduce the installation steps required for fastening the fasteners 13. The screw holes 210 may be original to the camera 2. The second portion 21 may be made of a metal material (e.g., an aluminum alloy or a zinc alloy) such that the fasteners 13 and the screw holes 210 of the second portion 21 are screwed more firmly.

Referring to FIGS. 1, 2, and 7 simultaneously, optionally, the inner housing 12 includes a first limiting portion 121. The first limiting portion 121 is spaced apart from the second snap-fit hole 120. The camera 2 is snap-fitted between an edge of the second snap-fit hole 120 and the first limiting portion 121. The first limiting portion 121 may have a strip-like cuboid shape. The first limiting portion 121 may be disposed on an inner surface of an upper side wall of the inner housing 12. A length direction of the first limiting portion 121 may be parallel to the second front wall 122. For example, the length direction of the first limiting portion 121 may be the direction parallel to the X-axis. The first limiting portion 121 may be integrally formed with the inner housing 12. The first limiting portion 121 can prevent the camera 2 from moving in a negative direction parallel to the Y-axis. The edge of the second snap-fit hole 120 may be an area on an inner surface of the second front wall 122 surrounding the second snap-fit hole 120. The camera 2 may be snap-fitted between the inner surfaces of the second front wall 122 and a front surface of the first limiting portion 121.

Referring to FIGS. 1 and 7 simultaneously, optionally, the inner housing 12 includes a second limiting portion 123. The second limiting portion 123 is spaced apart from the first limiting portion 121. The second portion 21 abuts against the second limiting portion 123. Two second limiting portions 123 may be provided. The second limiting portions 123 may be two side plates of the inner housing 12, i.e. the second limiting portions 123 may be parallel to a YOZ plane. The second limiting portions 123 may be formed integrally with the inner housing 12. The second limiting portions 123 may include transition segments 1230, contours of which matches side edges of the second portions 21 so that the second limiting portions 123 can more precisely snap-fit the second portion 21. The second limiting portions 123 can prevent the camera 2 from moving in the positive direction parallel to the Y-axis.

Referring to FIGS. 1 and 7 simultaneously, optionally, the inner housing 12 includes notches 124. The second limiting portions 123 are located at edges of the notches 124. The second portion 21 is exposed at the notches 124. The notches 124 may be disposed on side plates of the inner housing 12, and the second limiting portions 123 may be located on left edges of the notches 124. For example, the left side plate and the right side plate of the inner housing 12 may be respectively provided with a notch 124. The notches 124 disposed on side walls of the inner housing 12 can save the material needed to form the inner housing 12. The contours of the notches 124 may be substantially L-shaped, which means that the second limiting portions 123 may be formed by removing the L-shaped notches 124 from the rectangular side plates of the inner housing 12. The second portion 21 exposed at the notches 124 may facilitate one end of the fastener 13 reaching the screw hole 210, which means that one end of the fastener 13 does not need to pass through the inner housing 12.

Referring to FIGS. 1, 2 and 7 simultaneously, optionally, the number of second limiting portions 123 is two, and a distance between the two second limiting portions 123 is approximately the same as a width of the camera body 23. The two second limiting portions 123 may be disposed parallel to each other. The distance between the two second limiting portions 123 may be equal to a distance between an inner surface of the left side plate and an inner surface of the right side plate of the inner housing 12. A width direction of the camera body 23 may be parallel to the X-axis, which means that the width of the camera body 23 may be a distance between the left side face and the right side face of the camera body 23. The distance between the two second limiting portions 123 is substantially the same as the width of the camera body 23 to prevent the camera 2 from moving left or right in the direction parallel to the X-axis as well as prevent the camera 2 from rotating around a central axis parallel to the Y-axis.

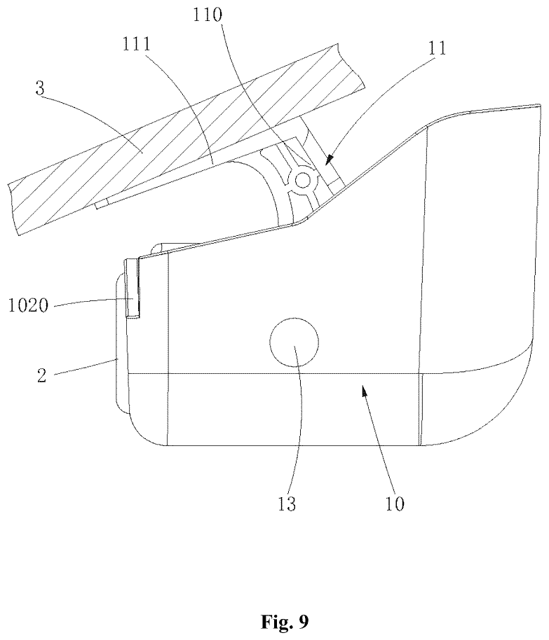

Referring to FIGS. 1 and 8 simultaneously, when using the fixing structure 1, the camera 2 may be fixed to the fixing structure 1 first. When it needs to be fixed to a windshield 3 of a pickup truck (the windshield 3 of the pickup truck has a tilt angle of about 90 degrees), the bracket 11 may be rotated to a suitable first angle, and then the fitting portion 111 may be adhered to the windshield 3. As shown in FIG. 9, when it needs to be fixed to a windshield 3 of a sports car (the windshield 3 of the sports car has a tilt angle of about 20 degrees), the bracket 11 may be rotated to a suitable second angle, and then the fitting portion 111 may be adhered to the windshield 3. Since the bracket 11 may rotate with respect to the camera 2 and the outer housing 10, the fixing structure 1 may also be adapted to fit the windshields 3 of other vehicle models with tilt angles between 20 and 90 degrees.

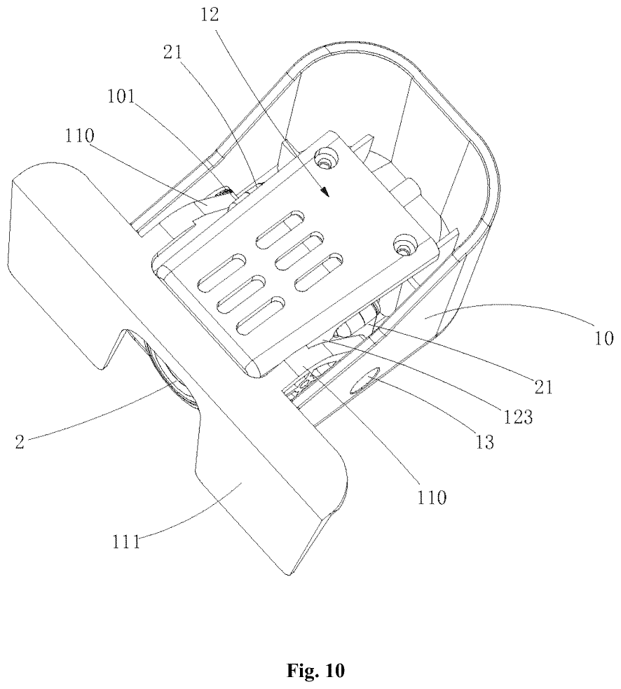

Referring to FIGS. 1, 2, and 10 simultaneously, the outer housing 10, the edge of the second snap-fit hole 120, the first limiting portion 121, the second limiting portion 123, and the inner housing 12 enclose an accommodating space, allowing the camera 2 to be caught within the accommodating space to achieve precise positioning and fixation of the camera 2, so that the camera 2 is not easily dislodged from the accommodating space, whether it moves or rotates. Moreover, the camera 2, as an intermediate connector, connects the inner housing 12 and the outer housing 10, eliminating the need for an excessive number of fastening components to connect the inner housing 12 and the outer housing 10, thereby ensuring greater efficiency in assembling the inner housing 12 and the outer housing 10.

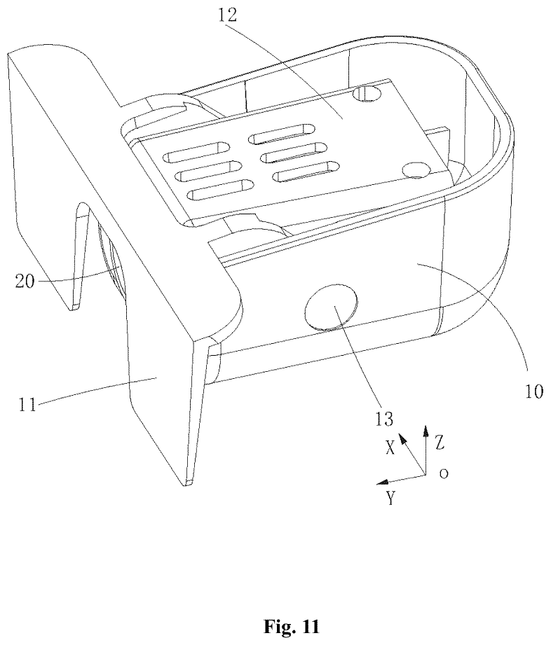

As shown in FIG. 11, in another embodiment, a portion of the outer housing 10 may be removed to avoid collisions between the outer housing 10 and a roof of the vehicle. That is, only the outer housing 10 in this embodiment is different from the outer housing 10 in the preceding embodiments, and the other parts are the same as in the preceding embodiments. For example, the outer housing 10 in this embodiment may be formed by removing an upper portion from a rear end of the outer housing 10 in the preceding embodiments such that a top surface of the outer housing 10, after removal, is substantially parallel to the XOY plane.

In a further embodiment, a camera device is provided. The camera device includes a camera 2 and the fixing structure 1 in the preceding embodiments. The camera 2 is fixed to the fixing structure 1. The camera 2 may be disposed within the fixing structure 1, and the fixing structure 1 may be fixed to the windshield 3 of the vehicle by adhesion.

The fixing structure and the camera device provided in the embodiments of the present application are described in detail above, and people skilled in the art can make changes in specific implementations and the application scope, based on the ideas of the embodiments of the present application. In summary, the contents of this specification shall not be construed as a limitation of the present application, and all equivalent modifications or changes made according to the spirit and technical ideas of the present application shall still be covered by the claims of the present application.

1. A fixing structure configured to fix a camera, the camera comprising a first portion and a second portion, the first portion and the second portion being located on different sides of the camera, wherein the fixing structure comprises:
an outer housing comprising a first snap-fit hole, wherein the first portion is snap-fitted in the first snap-fit hole;
a bracket rotatably connected to the outer housing, wherein the second portion is rotatably connected to the bracket and the second portion is connected to the outer housing; and
an inner housing comprising a second snap-fit hole, wherein the first portion is snap-fit in the second snap-fit hole, and the inner housing is connected to the outer housing.

2. The fixing structure according to claim 1, wherein an inner side of the outer housing comprises a first snap-fit teeth portion, an outer side of the bracket comprises a second snap-fit teeth portion, and the second snap-fit teeth portion and the first snap-fit teeth portion are coaxially disposed and engage with each other.

3. The fixing structure according to claim 2, wherein the first snap-fit teeth portion comprises multiple first snap-fit teeth, the second snap-fit teeth portion comprises multiple second snap-fit teeth, and the number of the first snap-fit teeth is less than the number of the second snap-fit teeth.

4. The fixing structure according to claim 2, wherein the outer housing comprises an avoidance slot, the bracket comprises a support arm, the second snap-fit teeth portion is provided on the support arm, and the avoidance slot is used to avoid the support arm.

5. The fixing structure according to claim 1, wherein the inner housing comprises a first limiting portion spaced apart from the second snap-fit hole, and the camera is snap-fitted between an edge of the second snap-fit hole and the first limiting portion.

6. The fixing structure according to claim 5, wherein the inner housing comprises a second limiting portion spaced apart from the first limiting portion, and the second portion abuts against the second limiting portion.

7. The fixing structure according to claim 6, wherein the inner housing comprises a notch, the second limiting portion is provided at an edge of the notch, and the second portion is exposed at the notch.

8. The fixing structure according to claim 6, wherein two second limiting portions are provided, and a distance between the two second limiting portions is approximately the same as a width of a camera body.

9. The fixing structure according to claim 1, wherein the fixing structure further comprises a fastener, the second portion comprises a screw hole, the outer housing comprises a first through hole, and the bracket comprises a second through hole, wherein a first end of the fastener is passed through the first through hole and the second through hole and screwed into the screw hole, and a second end of the fastener abuts against an edge of the first through hole.

10. A camera device comprising a camera and the fixing structure according to claim 1, wherein the camera is fixed to the fixing structure.
